(19) United States
(12) Patent Application Publication
(10) Pub. No.: US 2010/0070532 A1
(43) Pub. Date: Mar. 18, 2010

(54) Storage device, content publishing system, and program

(75) Inventors: Hirotaka Moribe, Yokohama (JP); Takaki Nakamura, Ebina (JP); Nobuaki Kohinata, Yokohama (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/314,296

(22) Filed: Dec. 8, 2008

(30) Foreign Application Priority Data
Sep. 18, 2008 (JP) 2008-239043

(51) Int. Cl. G06F 17/30

(52) U.S. Cl. 707/783; 707/E17.044; 707/E17.001

(57) ABSTRACT

In order to prevent the same content from being published in duplicate, the invention provides a storage device which provides a storage area for storing content in accordance with a request from a user and can publish the stored content in which the storage area includes publishing content storage area which publishes the stored content to outside, duplication identification information for determining duplication of content is generated based on accepted content, publishing content is generated by embedding a digital watermark including identification information of the user to the accepted content if duplicate content of the accepted content is not stored in the storage area, the publishing content is stored in the publishing content storage area, and the content is not stored in the publishing content storage area if the duplicate content of the accepted content is stored in the storage area.

### CROSS REFERENCES TO RELATED APPLICATIONS

This application relates to and claims priority from Japanese Patent Application No. 2008-239043, filed on Sep. 18, 2008, the entire disclosure of which is incorporated herein by reference.

### BACKGROUND OF THE INVENTION

1. Field of the Invention

The present invention relates to a technique for publishing content stored in a storage device.

2. Description of the Related Art

In recent years, services have been provided in which digital content such as photographs, videos, and music is published in a viewable or playable state via a network such as a mobile phone network or an Internet network. In a site where photographs are shared, photographic content is uploaded, and a content viewer can acquire the published photographic content at the time of publishing. The same goes to a video posting site and a music distribution site.

Some sites display ads on part of a screen where content is published and take a system to share profits between a site operator and a user (content poster). Further, a music distribution site or the like takes a system to get paid for a file by download-selling the file. In such a case, there is a risk that the original content poster who has a right of the content would lose profits if a third party reproduces the content without permission.

In order to solve the problem, a storage device has been proposed in which information of a content distributor and information capable of specifying an acquirer of content are embedded to the content as a digital watermark to enable the ascertainment of distribution channel of the content, whereby illegal secondary use of the content is suppressed (for example, refer to JP-A-2006-338439 (Patent Document 1)).

### SUMMARY OF THE INVENTION

However, the technique disclosed in Patent Document 1 cannot cope with the case where in a site having a function of publishing and sharing content, a content viewer acquires published content and posts the content to the site again, whereby the content is published in duplicate. Further, when the content which was posted again is acquired, a person who posted the content for the second time can be the content distributor. Accordingly, when the acquisition and posting of content are repeated, the original distributor (first poster) cannot be specified.

The invention has been made in view of the problem, and an object thereof is to provide a technique for preventing content from being published in duplicate by a third party who is not the first poster.

A typical aspect of the invention provides a storage device which provides a storage area for storing content in accordance with a request from a user and can publish the stored content. The storage device includes an interface, a processor connected to the interface, and a memory connected to the processor. The memory stores user management information including identification information of a user who can access the storage area. The storage area includes publishing content storage area which publishes the stored content to outside. The processor accepts a content storage request from the user, generates duplication identification information for determining duplication of content based on the accepted content, determines whether or not duplicate content of the accepted content is stored in the storage area based on the generated duplication identification information, embeds a digital watermark including identification information of the user to the accepted content, thereby generating publishing content when the duplicate content of the accepted content is not stored in the storage area, stores the publishing content in the publishing content storage area, and does not store the content in the publishing content storage area when the duplicate content of the accepted content is stored in the storage area.

According to an aspect of the invention, it is possible to prevent content stored (uploaded) in a storage device from being published in duplicate.

### BRIEF DESCRIPTION OF THE DRAWINGS

FIG. 1 shows an example of a configuration of a content publishing system according to an embodiment of the invention;

FIG. 2 shows an example of a hardware configuration of a storage device according to the embodiment of the invention;

FIG. 3 is a functional block diagram of the storage device according to the embodiment of the invention;

FIG. 4 shows an example of an original content table included in an original content retention unit according to the embodiment of the invention;

FIG. 5 shows an example of a publishing content table included in a publishing content retention unit according to the embodiment of the invention;

FIG. 6 is a flowchart showing a procedure of upload processing for uploading content from a user terminal to the storage device according to the embodiment of the invention; and

FIG. 7 is a flowchart showing a procedure of viewing and download processing for viewing publishing content stored in the storage device and downloading the publishing content to a user terminal according to the embodiment of the invention.

### DESCRIPTION OF THE PREFERRED EMBODIMENT

Hereinafter, a content publishing system 1 according to an embodiment of the invention will be described with reference to the drawings.

### (System Configuration)

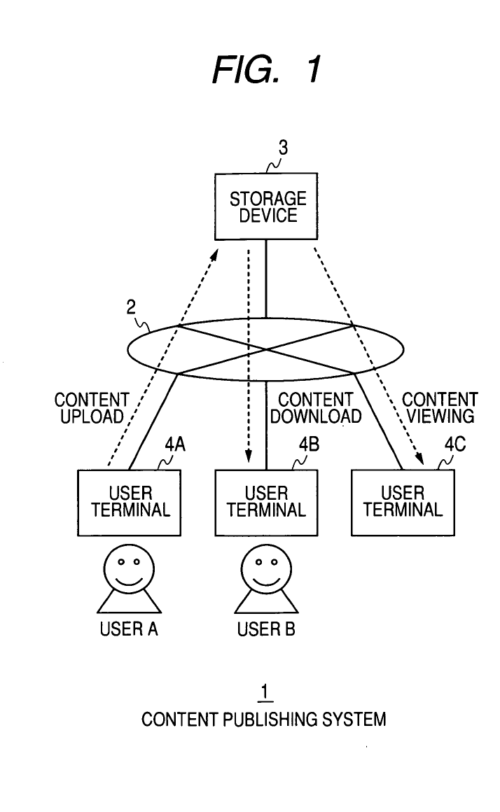

FIG. 1 shows an example of a configuration of the content publishing system 1 according to the embodiment of the invention.

The content publishing system 1 according to the embodiment of the invention includes a storage device 3 and user terminals 4A, 4B, and 4C. The user terminals 4A, 4B, and 4C each can be connected to the storage device 3 via a data communication network 2. When the content common to the user terminals 4A, 4B, and 4C is described, they are referred to as a user terminal 4.

The data communication network 2 is the Internet network configured by connecting, for example, a mobile phone network and a wireless or wired LAN (Local Area Network) to each other.

The storage device 3 stores content to be provided to the user terminal 4. Further, the storage device 3 manages the stored content.

The user terminal 4 is connected to the storage device 3 via the data communication network 2, can be communicated to each other, and is specifically a mobile phone having a communication function, a personal computer, a digital camera, a digital video camera, for example. The user terminal 4 transmits and receives content to and from the storage device 3 by using a protocol such as HTTP (Hyper Text Transport Protocol) via the data communication network 2. For example, a user stores (uploads) content held in the user terminal 4A in the storage device 3 or views a screen where content is published with the user terminal 4B and acquires (downloads) the viewed content from the storage device 3.

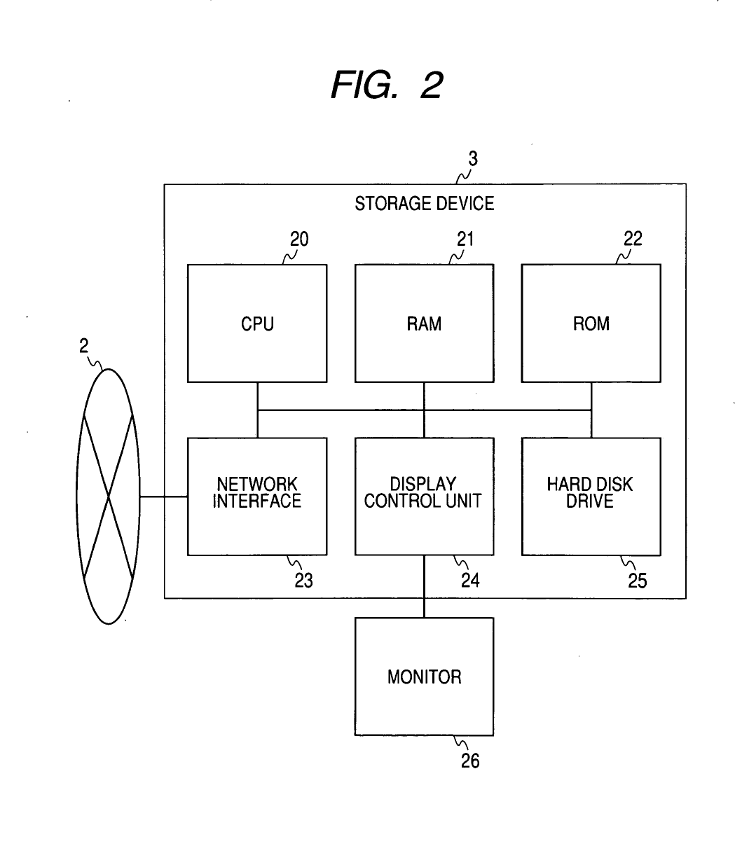

FIG. 2 shows an example of a hardware configuration of the storage device 3 according to the embodiment of the invention.

The storage device 3 includes a CPU 20, a RAM (Random Access Memory) 21, a ROM (Read Only Memory) 22, a network interface 23, a display control unit 24, and a hard disk drive 25.

The CPU 20 executes programs stored in the RAM 21 or the ROM 22, thereby controlling the entire storage device 3.

The RAM 21 stores the programs executed by the CPU 20 and data used at the time of executing the programs. The ROM 22 stores the programs executed by the CPU 20 and the data used at the time of executing the programs. Information stored in the RAM 21 can be updated, whereas information stored in the ROM 22 cannot be generally changed by executing a program or the like because it is read-only information.

The network interface 23 is an interface which is connected to the data communication network 2. Content stored in the hard disk drive 25 is distributed via the network interface 23.

The display control unit 24 performs the control for displaying management information of the storage device 3 or the like on a monitor 26. The storage device 3 may be configured not to include the display control unit 24 by separately disposing a management terminal.

The hard disk drive 25 stores content uploaded by a user via the user terminal 4. Instead of a magnetic-storage device, other memory media such as a flash memory may be used for the hard disk drive 25. Further, the system may be configured to connect to a storage device disposed outside.

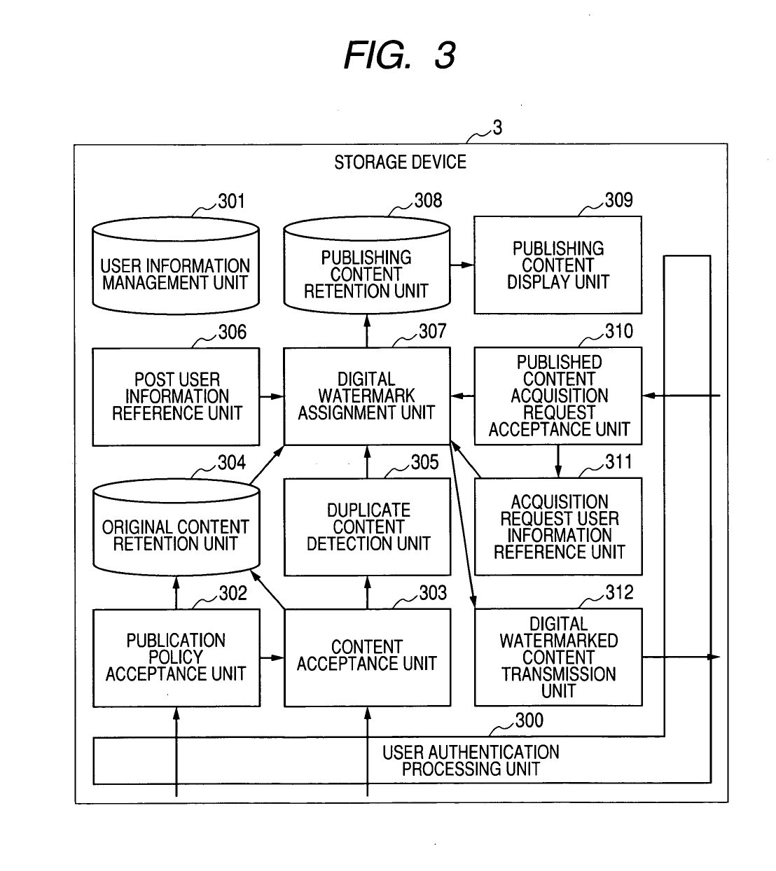

FIG. 3 is a functional block diagram of the storage device 3 according to the embodiment of the invention.

The storage device 3 includes a user authentication processing unit 300, a user information management unit 301, a publication policy acceptance unit 302, a content acceptance unit 303, an original content retention unit 304, a duplicate content detection unit 305, a post user information reference unit 306, a digital watermark assignment unit 307, a publishing content retention unit 308, a publishing content display unit 309, a published content acquisition request acceptance unit 310, an acquisition request user information reference unit 311, and a digital watermarked content transmission unit 312.

In each of the function units (300 to 312), programs stored in the hard disk drive 25 or the ROM 22 are loaded into the RAM 21 and executed by the CPU 20, whereby processing is performed. In the embodiment of the invention, although the storage device 3 provides all the functions alone, one or more devices connected with one another via a network may provide a part or all of the functions.

The user authentication processing unit 300 authenticates access to the storage device 3 based on information transmitted from the user terminal 4 when the user terminal 4 connects to the storage device 3 via the data communication network 2. Specifically, the information transmitted from the user terminal 4 includes identification information of the user terminal 4 and identification information of a user (user name, password, and the like) who requests an authentication from the user terminal 4. The user authentication processing unit 300 performs authentication based on the information transmitted from the user terminal 4 and user information stored in the user information management unit 301. Then, the user authentication processing unit 300 disconnects the connection when the authentication is requested from the user terminal 4 which is invalid or an invalid user, while establishing the connection when the authentication succeeded.

The user information management unit 301 manages information of a user who accesses the storage device 3 via the user terminal 4. The user information management unit 301 includes data indicating the user information itself and programs for inputting the user information or the like. For example, the user information is input when a user connects to the storage device 3 from the user terminal 4 for the first time. For example, the user information to be registered includes a user name, a password, a terminal ID unique to the user terminal 4, an e-mail address, a credit card number, and a zip code. The combination of a user name and a terminal ID unique to the user terminal 4 does not overlap in the entire storage device 3.

When content transmitted from the user terminal 4 is stored in the storage device 3, the publication policy acceptance unit 302 accepts input of policy of whether the content is “to be published” or “not to be published” to other users. Further, when a user selects “to be published”, the publication policy acceptance unit 302 can accept input of information such as a user to whom the content is to be published and a license regarding the content as an additional policy.

The content acceptance unit 303 receives content transmitted from the user terminal 4 via the data communication network 2 and stores the content in the original content retention unit 304.

The original content retention unit 304 stores the content accepted by the content acceptance unit 303 and information which manages the accepted content. The information which manages the accepted content is stored in an original content table 400.

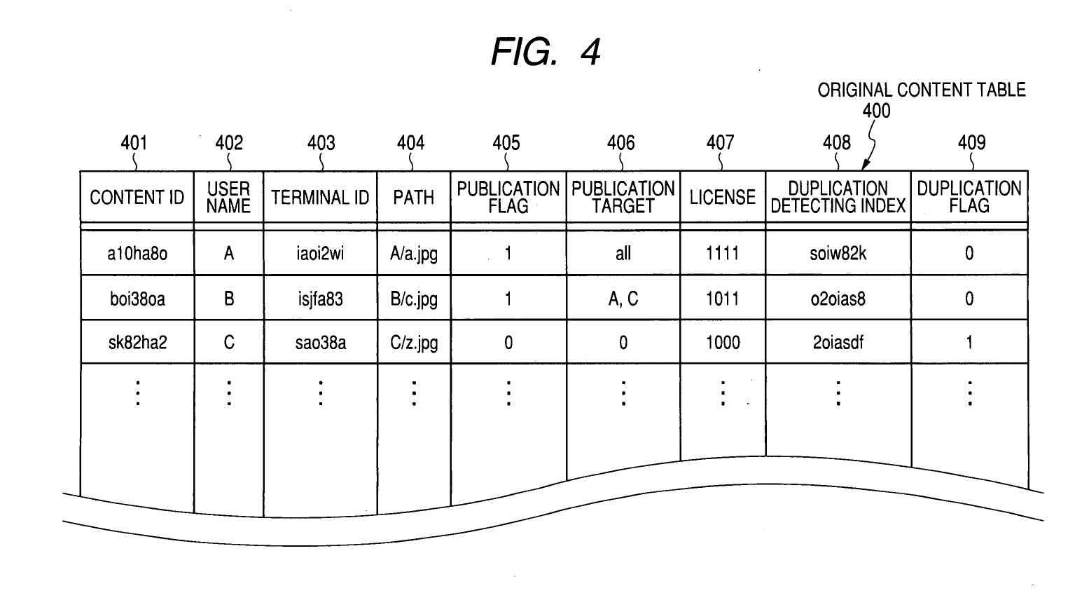

For example, the original content table 400 includes a path indicating a storage place of content, a content ID uniquely identifying content, a publication policy set to content by the publication policy acceptance unit 302, and information of a user who registered content. The original content table 400 will be described in detail later with reference to FIG. 4.

Further, the original content retention unit 304 includes a program having a function for generating a content ID. The program is executed when accepted content is stored, and a generated content ID is assigned to the accepted content.

The duplicate content detection unit 305 checks whether or not the same content as the content accepted by the content acceptance unit 303 has been uploaded by another user when “to be published” is selected by the publication policy acceptance unit 302. That is, the duplicate content detection unit 305 detects the content having the same content stored in the original content retention unit 304 and uploaded by another user.

For example, as a method for checking the duplication, there are a method for comparing hash values calculated based on content data and a method for comparing bit strings of content if the content have the same format. As a method not depending on the content format, there is a method for comparing indexes extracted from feature points of the content, for example.

According to the embodiment of the invention, index information is generated based on feature points of accepted content, and the generated index information is recorded in the original content table 400 as a duplication detecting index. Further, a duplication detecting index of accepted content is compared with duplication detecting indexes of other content, whereby the presence or absence of duplication is determined, and a value is set to the flag indicating the presence or absence of duplication in the original content table 400.

When the duplicate content detection unit 305 determines that accepted content duplicates none of contents recorded in the original content retention unit 304, the post user information reference unit 306 acquires information of a user who has uploaded the content from the user information management unit 301 if necessary.

The digital watermark assignment unit 307 embeds, to content which is determined not to be a duplicate by the duplicate content detecting unit 305, part or all of information regarding the content acquired from the original content table 400 and information of a user who uploaded the content acquired from the post user information reference unit 306 as a digital watermark.

There are two types of digital watermarks: visible and invisible. In the embodiment of the invention, an invisible digital watermark is embedded. This is because when content is viewed by a third party, it is preferable in some cases that the content is viewed in a state close to its original. Further, a provision source of content or the like may be clearly shown to a third party with an visible digital watermark without largely affecting the viewing of the content.

The digital watermark assignment unit 307 is used not only when content is stored but also when content is acquired and assigns a digital watermark including information of an acquirer to content to be acquired. Specifically, the digital watermark assignment unit 307 first acquires information of the corresponding content and the content itself from the original content retention unit 304 based on a content ID in accordance with a direction from the published content acquisition request acceptance unit 310. Next, the digital watermark assignment unit 307 acquires user information of a poster of the content with the post user information reference unit 306 and further acquires user information of an acquirer of the content with the acquisition request user information reference unit 311. Then, the digital watermark assignment unit 307 generates a digital watermark including the acquired information and embeds the generated digital watermark to the content.

The publishing content retention unit 308 stores publishing content embedded with a digital watermark by the digital watermark assignment unit 307 and information which manages publishing content. The information which manages publishing content is stored in a publishing content table 500.

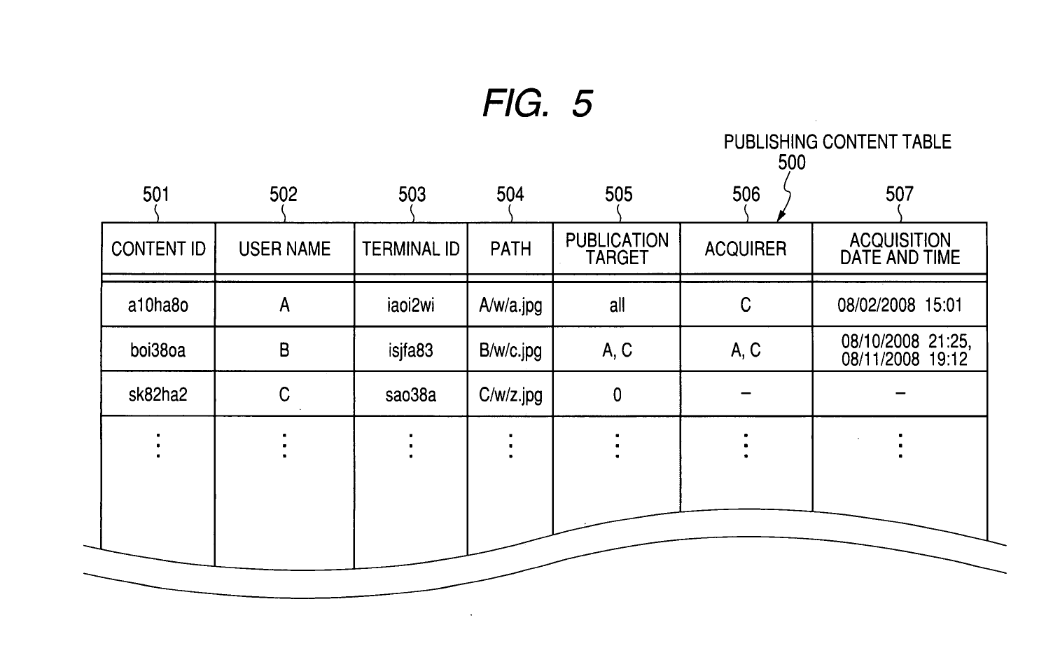

The publishing content table 500 includes a content ID assigned by the original content retention unit 304, a path indicating a storage place of content, a publication target of the corresponding content, and information of a user who stored the content. The publishing content table 500 will be described in detail later with reference to FIG. 5.

The publishing content display unit 309 publishes content stored in the publishing content retention unit 308. Specifically, when a user (viewer) requests the viewing of content, the publishing content display unit 309 determines whether or not the requested content is included in the publication target based on the publishing content table 500. When the content is included in the publication target, the publishing content display unit 309 reads the corresponding content from the publishing content retention unit 308 and displays the content. The published content is protected so as not to be acquired from the publishing content display unit 309. Even when the published content is acquired by some means, a right of a poster can be retained because information such as a user name of the poster is embedded to the content as a digital watermark.

The published content acquisition request acceptance unit 310 accepts an acquisition (download) request of content from a user who viewed content. Further, the published content acquisition request acceptance unit 310 commands the digital watermark assignment unit 307 to generate digital watermarked content to be acquired by a user.

The acquisition request user information reference unit 311 acquires information of a user who requests the acquisition of content from the user information management unit 301.

The digital watermarked content transmission unit 312 acquires content embedded with a digital watermark including the information of a user who requested the acquisition of content and transmits the content to the user who requested the acquisition of content.

FIG. 4 shows an example of the original content table 400 included in the original content retention unit 304 according to the embodiment of the invention.

The original content table 400 stores management information of content uploaded to the storage device 3. In the original content table 400, information input when a user uploads content, identification information of content generated by the original content retention unit 304, and the like are stored.

The original content table 400 includes a content ID 401, a user name 402, a terminal ID 403, a path 404, a publication flag 405, a publication target 406, a license 407, a duplication detecting index 408, and a duplication flag 409.

The content ID 401 is an identifier uniquely identifying content uploaded to the storage device 3. The user name 402 is a name of a user who uploaded content identified by the content ID 401.

The terminal ID 403 is an identifier of the user terminal 4 which uploaded content identified by the content ID 401. The user terminal 4 can be uniquely specified with the terminal ID 403.

The path 404 is information indicating a storage place of content identified by the content ID 401. For example, the combination of a directly name and a file name is stored therein.

The publication flag 405 is a flag indicating whether or not content identified by the content ID 401 is to be published to the outside. For example, “1” is stored therein when content is to be published, while “0” is stored when content is not to be published.

The publication target 406 is information indicating a target to whom content is published when content identified by the content ID 401 is published. Specifically, “all” is stored therein when content is to be published to all users, while identification information such as a user name of a user to whom content is published is stored when content is to be published only to a specific user.

The license 407 stores license information of content identified by the content ID 401. For example, distribution conditions of content and the like are stored therein.

The duplication detecting index 408 is a duplication detecting index generated based on content identified by the content ID 401. As described above, according to the embodiment of the invention, the duplication detecting index 408 is a unique value which is generated based on feature points of content and is different for each content.

The duplication flag 409 is information indicating whether or not content identified by the content ID 401 is stored in duplicate in the storage device 3. For example, when a third party acquires published content, and further the third party uploads the acquired content, the content exists in duplicate. “1” is stored therein when the content exists in duplicate, while “0” is stored when the content does not exist in duplicate.

FIG. 5 shows an example of the publishing content table 500 included in the publishing content retention unit 308 according to the embodiment of the invention.

The publishing content table 500 stores management information of content published by the storage device 3.

The record of the publishing content table 500 is generated together with the record of the original content table 400 when the content is uploaded to the storage device 3 with the designation of “to be published”. The record is generated in the publishing content table 500 also when content stored in the original content retention unit 304 is changed from “not to be published” to “to be published”.

The publishing content table 500 includes a content ID 501, a user name 502, a terminal ID 503, a path 504, a publication target 505, an acquirer 506, and an acquisition date and time 507.

The content ID 501 is an identifier uniquely identifying content stored in the publishing content retention unit 308. In the original content retention unit 304, original content not embedded with a digital watermark is stored corresponding to publishing content, and the record corresponding to the content is included in the original content table 400. Therefore, common identifiers with the content ID 401 of the original content table 400 are used for the content ID 501 of the publishing content table 500.

The user name 502 is a name of a user who uploaded content identified by the content ID 501 and is in common with the user name 402 of the original content table 400.

The terminal ID 503 is an identifier of the user terminal 4 which uploaded content identified by the content ID 501 and is in common with the terminal ID 403 of the original content table 400.

The path 504 is information indicating a storage place of content identified by the content ID 501. The form of data to be stored therein is the same as that of the path 404 of the original content table 400. However, since content to be published is embedded with a digital watermark, it is stored in a place different from that of the original content. That is, a path indicating an area where publishing content is stored is stored in the path 504.

The publication target 505 is information indicating a target to whom content identified by the content ID 501 is published and is in common with the publication target 406 of the original content table 400.

The acquirer 506 is a user name of a user (acquirer) who acquired publishing content. The acquisition date and time 507 is the date and time when published content is acquired. The acquirer 506 and the acquisition date and time 507 are recorded, whereby they can be utilized for specifying a distribution channel when content has been illegally distributed.

As described above, the content ID 501, the user name 502, the terminal ID 503, and the publication target 505 correspond to the content ID 401, the user name 402, the terminal ID 403, and the publication target 406 of the original content table 400, respectively. The above-described information is not input anew by a user but information input when content is uploaded or information stored in the original content table 400 is set.

### (System Processing)

Hereinafter, processing executed by the storage device 3 according to the embodiment of the invention will be described in detail. Specifically, upload processing of content and viewing and acquiring processing of content will be described.

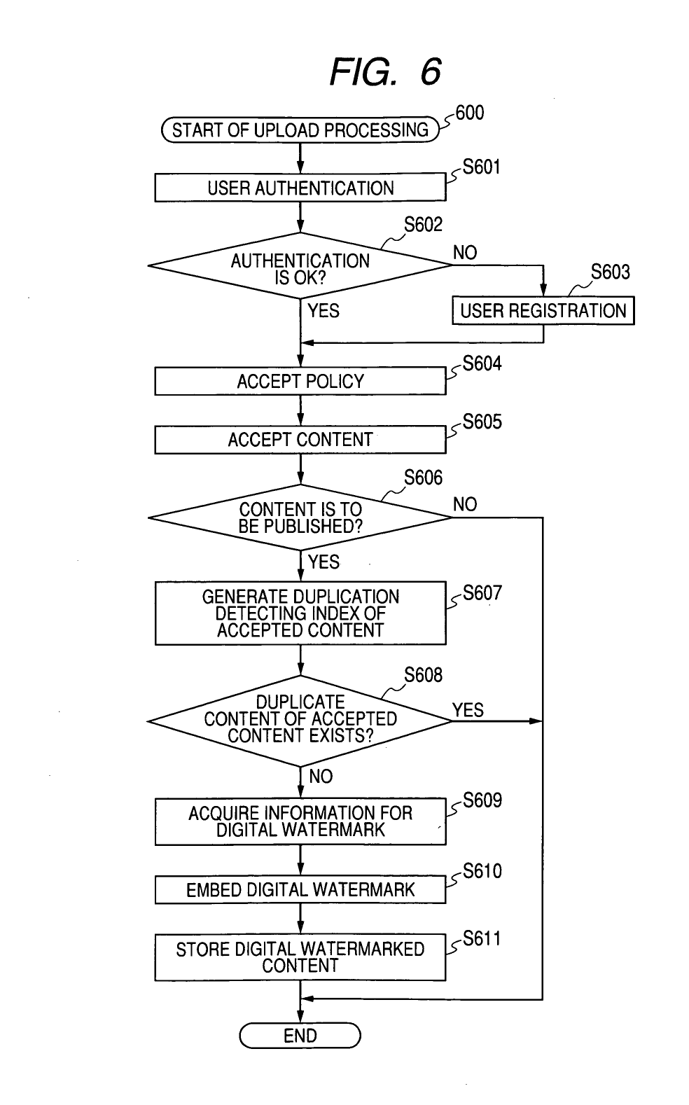

The upload processing of content is processing from when content is uploaded from the user terminal 4 to the storage device 3 until publishing content of the uploaded content is generated and stored. The upload processing will be described in detail with reference to FIG. 6.

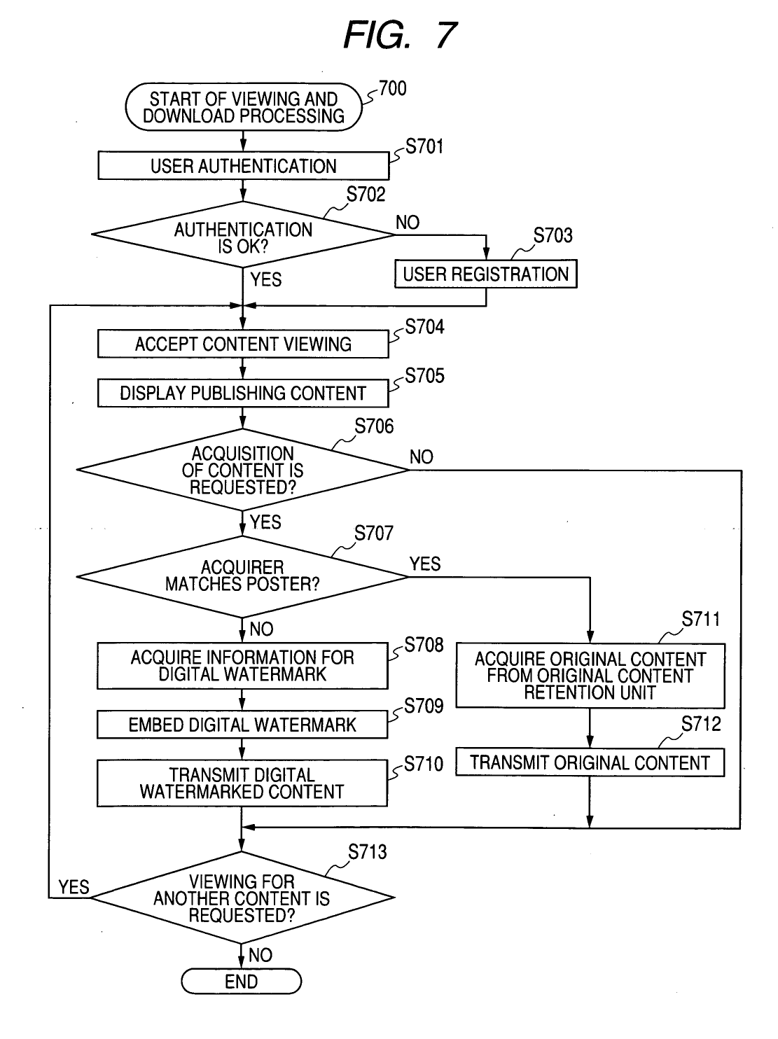

Viewing and download processing of content is processing from when publishing content is viewed until acquiring content of the viewed content is generated, and the generated acquiring content is provided. The viewing and the download processing will be described in detail with reference to FIG. 7.

### ===Upload Processing===

FIG. 6 is a flowchart showing a procedure of upload processing 600 for uploading content from the user terminal 4 to the storage device 3 according to the embodiment of the invention.

The upload processing 600 is executed at a timing when content is uploaded from the user terminal 4. Further, the programs included in each of the configurations (300 to 312) shown in FIG. 3 are processed by the CPU 20 of the storage device 3, whereby the upload processing 600 is executed.

The CPU 20 of the storage device 3 authenticates a user by checking information such as a user name and a password transmitted from the user terminal 4 against user information recorded in the user information management unit 301 with the user authentication processing unit 300 (S601).

The CPU 20 of the storage device 3 determines whether or not the user authentication succeeded with the user authentication processing unit 300 (S602). When the authentication failed, such as when the corresponding user name does not exist (the result of S602 is “NO”), the CPU 20 executes user registration processing (S603).

The user registration processing (S603) is processing which registers information such as a user name and the user terminal 4 in the user information management unit 301. The program which executes the user registration processing may be included in the user authentication processing unit 300 or in the user information management unit 301. For example, the information to be registered includes a user name, a password, a terminal ID unique to the user terminal 4, an e-mail address, a credit card number, and a zip code.

When the user authentication succeeded (the result of S602 is “YES”) or when the registration of user information was completed, the CPU 20 of the storage device 3 accepts input of publication policy of content to be uploaded with the publication policy acceptance unit 302 (S604). For example, the publication policy includes the designation of whether the content to be uploaded is “to be published” or “not to be published”, a target to whom the content is published when the content is to be published, and the license information of the content. When the publication policy is accepted, information included in the publication policy is stored in the original content table 400 of the original content retention unit 304.

The CPU 20 of the storage device 3 accepts content uploaded from the user terminal 4 with the content acceptance unit 303 and stores the content in the original content retention unit 304 (S605).

The CPU 20 of the storage device 3 acquires the publication policy input in the processing of S604 from the original content table 400 of the original content retention unit 304 with the content acceptance unit 303 and determines whether or not the accepted content is published (S606). When the accepted content is not to be published (the result of S606 is “NO”), the CPU 20 does not store the accepted content in the publishing content retention unit 308 and ends the processing.

When the accepted content is to be published (the result of S606 is “YES”), the CPU 20 of the storage device 3 generates the duplication detecting index of the accepted content with the duplicate content detection unit 305 (S607). The generated duplication detecting index is written into the duplication detecting index 408 of the record corresponding to the content of the original content table 400 of the original content retention unit 304.

The duplication detecting index is generated for determining whether or not duplicate content of the accepted content is stored in the original content retention unit 304. As described above, the duplication detecting index is generated by extracting feature points of the accepted content.

The CPU 20 of the storage device 3 compares the duplication detecting index generated in the processing of S607 with the duplication detecting index 408 of each record of the original content table 400 to determine whether or not the same content has already existed with the duplicate content detection unit 305 (S608). When the content having a duplication detecting index that matches the duplication detecting index of the accepted content is detected, and it is determined that the duplicate content exists (the result of S608 is “YES”), the CPU 20 does not store the accepted content in the publishing content retention unit 308 and ends the processing. That is, the CPU 20 ends the processing without publishing the accepted content.

When the duplicate content of the accepted content does not exist in the original content retention unit 304 (the result of S608 is “NO”), the CPU 20 of the storage device 3 acquires information necessary for generating a digital watermark with the digital watermark assignment unit 307 (S609). The information necessary for generating a digital watermark is acquired with the post user information reference unit 306 and the original content retention unit 304. As described above, the information necessary for generating a digital watermark includes a user name of a user who uploaded the content.

The CPU 20 of the storage device 3 embeds the information necessary for generating a digital watermark acquired in the processing of S609 to the accepted content as a digital watermark with the digital watermark assignment unit 307 (S610).

The CPU 20 of the storage device 3 stores the content to which the information of a user who uploaded the content is embedded as a digital watermark in the publishing content retention unit 308 with the digital watermark assignment unit 307 (S611) and ends the processing.

The procedure for generating content in which information of a user is embedded, when content is uploaded from the user terminal 4 to the storage device 3, to the content as a digital watermark and storing the content to the storage device 3 has been described so far.

In the upload processing 600, uploaded content is stored in the original content retention unit 304 irrespective of whether the content is “to be published” or “not to be published”. Therefore, the system can function as a general online storage system. When content which a user intended to upload has been uploaded by another user, the user cannot publish the content by him/herself as a poster. Accordingly, the content publishing system 1 according to the embodiment of the invention can prevent the same content from being published in duplicate by another user.

### ===Viewing and Download Processing===

FIG. 7 is a flowchart showing a procedure of viewing and download processing 700 for viewing publishing content stored in the storage device 3 according to the embodiment of the invention and downloading the publishing content to the user terminal 4.

The viewing and download processing 700 is executed at a timing when the viewing of content is requested from the user terminal 4. Similarly to the upload processing 600, the programs included in each of the configurations (300 to 312) shown in FIG. 3 are processed by the CPU 20 of the storage device 3, whereby the viewing and download processing 700 is executed.

The CPU 20 of the storage device 3 authenticates a user by checking information such as a user name and a password transmitted from the user terminal 4 against user information recorded in the user information management unit 301 with the user authentication processing unit 300 (S701).

The CPU 20 of the storage device 3 determines whether or not the user authentication succeeded with the user authentication processing unit 300 (S702). When the authentication failed, such as when the corresponding user name does not exist (the result of S702 is “NO”), the CPU 20 executes user registration processing similarly to the case of the upload processing 600 (S703). Since the user registration processing is the same as that of the upload processing 600 (processing in S603 in FIG. 6), the description thereof is omitted.

In the content publishing system 1 according to the embodiment of the invention, a members-only site, which requires user registration for viewing content, is assumed. However, user authentication may not be required in the case of only viewing content. In this case, user authentication is performed when published content is acquired.

The CPU 20 of the storage device 3 accepts the designation of content requested in order to display the content in the user terminal 4 (S704) with the publishing content display unit 309. Further, the CPU 20 acquires the content requested in the processing of S704 from the publishing content retention unit 308 and displays the acquired publishing content on a user interface provided by the user terminal 4 (S705). For example, when the user interface provided by the user terminal 4 is a Web browser, the CPU generates an HTML file for displaying the requested content and transmits the content to the user terminal 4. The displayed content is set so as not to be acquired from the user interface of the user terminal 4.

The CPU 20 of the storage device 3 determines whether or not a user requested to download the content displayed on the user interface of the user terminal 4 in the processing of S705 with the publishing content acquisition request acceptance unit 310 (S706).

When the acquisition of the content displayed in the user terminal 4 is requested (the result of S706 is “YES”), the CPU 20 of the storage device 3 determines whether or not the user who requested the acquisition of the published content is the poster of the content with the published content acquisition request acceptance unit 310 (S707). As a method for determining whether or not the user who requested the acquisition of the published content is the poster of the content, the determination may be made on the digital watermark embedded to the published content or may be made by referring to the publishing content table 500.

When the user who requested the acquisition of the published content is not the poster of the content (the result of S707 is “NO”), the CPU 20 of the storage device 3 acquires information necessary for generating a digital watermark with the digital watermark assignment unit 307 (S708). The information necessary for generating a digital watermark is acquired from the original content table 400 of the original content retention unit 304 with the acquisition request user information reference unit 311 and the post user information reference unit 306. Further, the CPU 20 acquires the requested content from the original content retention unit 304.

The CPU 20 of the storage device 3 embeds the information necessary for generating a digital watermark acquired in the processing of S708 to the content acquired in the processing of S705 as a digital watermark with the digital watermark assignment unit 307 (S709). Further, the CPU 20 transmits the digital watermarked content generated in the processing of S709 to the user terminal 4 with the digital watermarked content transmission unit 312 (S710).

On the other hand, when the user who requested the acquisition of the published content is the poster of the content (the result of S707 is “YES”), the CPU 20 of the storage device 3 acquires the content corresponding to the designated published content from the original content retention unit 304 (S711). Further, the CPU 20 transmits the acquired original content to the user terminal 4 (S712). According to the embodiment of the invention, when a poster of content acquires the content which the poster him/herself published, the original content is provided since it is not necessary to assign a digital watermark to specify the distribution source of content.

When the transmission of the requested content is completed, or when the acquisition of the displayed content is not requested (the result of S706 is “NO”), the CPU 20 of the storage device 3 accepts a request to view another content with the publishing content display unit 309 (S713). When the request to view another content is accepted due to the screen transition of the user interface of the user terminal 4 or the like (the result of S713 is “YES”), the CPU 20 proceeds to the processing of S704. When the viewing is not requested, such as when the connection between the storage device 3 and the user terminal 4 is disconnected (the result of S713 is “NO”), the CPU 20 ends the processing.

The procedure for displaying publishing content when the viewing of the content is requested from the user terminal 4 to the storage device 3 has been described so far. Further, the procedure for generating, when the acquisition of content is requested, content embedded with a digital watermark including information of a user who uploaded the requested content and information of a user who requested the content and transmitting the generated content to the user terminal 4 has been described.

In the viewing and download processing 700, when the published content is acquired by users other than the poster of the published content, content embedded with information of a poster and information of an acquirer as a digital watermark is provided. Accordingly, in the content publishing system 1 according to the embodiment of invention, a distribution source can be specified even when content is published to another site without permission since the information such as a provider and an acquirer is embedded to the content itself.

### (Specific Example of System Processing)

Here, in the content publishing system 1 shown in FIG. 1, the upload processing 600 shown in FIG. 6 and the viewing and download processing 700 shown in FIG. 7 will be described specifically with reference to FIG. 4 and FIG. 5.

First, in the upload processing 600, a specific example of processing from when a user A uploads content “a.jpg” from the user terminal 4A to the storage device 3 until publishing content of the content is generated and stored will be described. Then, in the viewing and download processing 700, a specific example of processing from when a user B views the publishing content of the content “a.jpg” with the user terminal 4B until the user B acquires acquiring content of the “a.jpg” will be described.

### ===Upload===

The upload processing 600 is executed at any timing, for example, when a user operates the user terminal 4. In the specific example of the upload processing 600 described below, the user terminal 4A is connected to the storage device 3 via the data communication network 2 due to the operation of the user A, and uploading the content “a.jpg” stored in the user terminal 4A to the storage device 3 is attempted.

The CPU 20 of the storage device 3 accepts a connection request from the user terminal 4A and starts the upload processing 600. Then, the CPU 20 receives information such as a user name of the user A, a password, and a terminal ID of the user terminal 4A and performs authentication of the user A based on the received information in the processing of S601 with the user authentication processing unit 300.

When the user terminal 4A is connected to the storage device 3 for the first time, since information corresponding to the combination of the user A and the user terminal 4A does not exist in the user information management unit 301 of the storage device 3, the authentication fails. Therefore, the storage device 3 registers the information such as a user name of the user A, a password, and a terminal ID in the user information management unit 301 in the processing of S603, whereby the authentication of the user A succeeds.

In the embodiment of the invention, although the user information and the terminal information are used for authentication to improve security, only the user information may be used for authentication without using the terminal information. This might lower the security but eliminates the need of a plurality of user registrations by one user on each terminal. Therefore, a user can upload and view content from terminals other than a specific terminal, whereby convenience will be improved.

The CPU 20 of the storage device 3 accepts input of publication policy such as to be published or not, a license form, and a publication range with respect to the “a.jpg” uploaded by the user terminal 4A in the processing of S604. The user A is allowed to select the publication policy via the user interface provided by the user terminal 4A, whereby the publication policy is input. The CPU 20 of the storage device 3 accepts the input of the selected policy with the publication policy acceptance unit 302 and records the policy in the original content table 400 of the original content retention unit 304.

The CPU 20 of the storage device 3 assigns a content ID “a10ha8o” which can be uniquely specified on the storage device 3 with respect to the “a.jpg” transmitted by the user terminal 4A upon storing in the original content retention unit 304. The content ID “a10ha8o” is shared among the function units from the publication policy acceptance unit 302 to the publishing content retention unit 308 of the storage device 3 during the execution of the upload processing 600. In the embodiment of the invention, the user A designates that the “a.jpg” is to be published to all the users registered in the user information management unit 301 of the storage device 3.

The CPU 20 of the storage device 3 receives the “a.jpg” transmitted by the user terminal 4A with the content acceptance unit 303 and stores it in the original content retention unit 304 in the processing of S605. The original content retention unit 304 writes a path indicating a location where the “a.jpg” is stored in the path 404 of the original content table 400 of the original content retention unit 304. In the embodiment of the invention, a directory where the “a.jpg” is stored is “A”, and therefore “A/a.jpg”, which is a combination with the file name “a.jpg”, is written in the path 404.

The CPU 20 of the storage device 3 generates a duplication detecting index based on feature points of the “a.jpg” with the duplicate content detection unit 305 in the processing of S607 in accordance with the policy of publishing the “a.jpg” accepted by the publication policy acceptance unit 302. The CPU 20 then searches the duplication detecting index of the original content table 400 of the original content retention unit 304 based on the generated duplication detecting index to check whether or not the same content has already existed.

Further, the CPU 20 of the storage device 3 writes the generated duplication detecting index in the duplication detecting index 408 of the content ID “a10ha8o” of the original content table 400 of the original content retention unit 304.

The CPU 20 of the storage device 3 confirms that the same content as the “a.jpg” does not exist in the original content retention unit 304 in the processing of S608 with the duplicate content detection unit 305. The CPU 20 then writes “0” indicating that no duplication exists in the duplication flag 409 of the record corresponding to the content ID “a10ha8o” of the original content table 400 of the original content retention unit 304.

The CPU 20 of the storage device 3 acquires the information of the user A from the user information management unit 301 via the post user information reference unit 306 in the processing of S609 with the digital watermark assignment unit 307. The CPU 20 further acquires information corresponding to the content ID “a10ha8o” from the original content table 400 of the original content retention unit 304.

The CPU 20 of the storage device 3 embeds a user name of the user A and the information of a license acquired in the processing of S609 to the “a.jpg” as a digital watermark in the processing of S610 with the digital watermark assignment unit 307. The CPU 20 then stores the digital watermarked content “a.jpg” to the publishing content retention unit 308 in the processing of S611. At that time, values of the user name, the terminal ID, the path 504 indicating the location of the digital watermarked “a.jpg”, the publication target 505 or the like are set for the record of the content ID “a10ha8o” of the publishing content table 500 of the publishing content retention unit 308.

As described above, the content “a.jpg” transmitted from the user terminal 4A by the user A is uploaded on the storage device 3, and the digital watermarked “a.jpg” embedded with the information of the user A or the like is generated and stored as publishing content.

### ===Viewing and Download===

The viewing and download processing 700 is executed at any timing, for example, when a user operates the user terminal 4. In the specific example of the viewing and download processing 700 described below, the user terminal 4B is connected to the storage device 3 via the data communication network 2 due to the operation of the user B, and viewing the content “a.jpg” published on the storage device 3 by the user terminal 4B and acquiring the viewed content “a.jpg” are attempted.

The CPU 20 of the storage device 3 accepts a connection request from the user terminal 4B and starts the viewing and download processing 700 with the user authentication processing unit 300. Then, the CPU 20 receives information such as a user name of the user B, a password, and a terminal ID of the user terminal 4B and performs authentication of the user B based on the received information in the processing of S701. When the information corresponding to the combination of the user B and the user terminal 4B has been registered in the user information management unit 301 of the storage device 3, the authentication of the user B succeeds.

The CPU 20 of the storage device 3 accepts a display request of content indicated by the content ID “a10ha8o” via the user interface of the user terminal 4B in the processing of S704 with respect to the publishing content display unit 309. The CPU 20 then refers to the publishing content table 500 of the publishing content retention unit 308 to check whether the user B has an authority to refer to the content having the content ID “a10ha8o”. As described above, since the content corresponding to the content ID “a10ha8o”, that is, the “a.jpg” can be published to all the users, the user B has the authority to refer to the content.

The CPU 20 of the storage device 3 acquires path information of the content corresponding to the content ID “a10ha8o” in order to display the requested content in the user terminal 4B in the processing of S705. Further, the CPU 20 reads the digital watermarked “a.jpg” stored in the publishing content retention unit 308 based on the acquired path information and transmits the “a.jpg” to user terminal 4B.

In this case, the digital watermarked “a.jpg” is displayed on the user interface of the user terminal 4B in a format that the “a.jpg” cannot be acquired via the user interface of the user terminal 4B.

The CPU 20 of the storage device 3 accepts that the user B performed an operation to require the acquisition of the digital watermarked “a.jpg” which is displayed via the user interface of the user terminal 4B in the processing of S706 with the published content acquisition request acceptance unit 310.

In this case, since a viewing user is the user B, and the “a.jpg” is the content which was published by the user A, the digital watermarked “a.jpg” is provided to the user B.

The CPU 20 of the storage device 3 acquires the information of the user B from the user information management unit 301 via the acquisition request user information reference unit 311 in the processing of S708 with the digital watermark assignment unit 307. Further, the CPU 20 acquires the information of the content ID “a10ha8o” from the original content table 400 of the original content retention unit 304 and the information of the user A from the user information management unit 301 via the post user information reference unit 306.

Subsequently, the CPU 20 of the storage device 3 embeds a user name of the user A, the license information of the content ID “a10ha8o”, and a user name of the user B among the information acquired in the processing of S708 to the “a.jpg” as a digital watermark in the processing of S709 with the digital watermark assignment unit 307. Then, the CPU 20 transmits the digital watermarked content “a.jpg” to the user terminal 4B in the processing of S710 with the digital watermarked content transmission unit 312.

The CPU 20 of the storage device 3 confirms that the user terminal 4B disconnected the connection with the storage device 3 in the processing of S713 with the publishing content display unit 309 and ends the processing.

As described above, the user B can view the content in which the information of the user A or the like is embedded as a digital watermark to the content “a.jpg” uploaded by the user A via the user interface of the user terminal 4B.

Further, in response to a request from the user terminal 4B to acquire the content “a.jpg” by downloading, content to which the information of the user A, the user B, and the license of the content “a.jpg” are embedded as a digital watermark is generated, and the generated content is transmitted to the user terminal 4B, whereby the user B can acquire the content.

### ADVANTAGE OF THE EMBODIMENT OF THE INVENTION

According to the embodiment of the invention, in the content publishing system 1, it is possible to prevent content stored in the storage device 3 from being published in duplicate by a third party. By preventing the content from being published in duplicate, a poster of the content can avoid loss of profits which can be obtained by publishing the content.

The profits which can be obtained by publishing the content is, for example, revenue of ads displayed on a page to which the content is published. More specifically, in the case where the ad revenue is calculated based on the number of times of viewing, when the same content is published in duplicate by a third party, the content is published to multiple pages. As a result, the number of times of viewing becomes smaller than the original number of times of viewing, whereby the ad revenue is not as much as it should be. The embodiment of the invention can avoid the loss of compensation attainment opportunities such as profit sharing due to the ad revenue of a storage device operator.

Similarly, in the content publishing system 1, when a system is designed so as to give a poster of content some incentive, it is necessary to provide a profit to a poster who uploaded the content first. Since the embodiment of the invention is configured so as to prevent content stored in the storage device 3 from being published in duplicate, it is possible to provide a profit only to the poster who uploaded the content first.

According to the embodiment of the invention, by unifying the management of content location and preventing content from being published in duplicate by a third party, license information such as use conditions of published content can be presented directly to a content acquirer. Accordingly, it is possible to directly encourage an acquirer of published content to use the content properly.

According to the embodiment of the invention, by embedding information of a poster of content and an acquirer of the content or the like to the content as a digital watermark and providing the content to the content acquirer, it is possible to ascertain a distribution source when the content is reproduced in other services which publish content. Accordingly, it is possible to suppress a license violation such as reproduction without permission by the acquirer of the published content.

According to the embodiment of the invention, since a user who acquires published content can check license information of the content or the like because the management of publication source is unified, the user can acquire and use the content in accordance with license conditions. Further, even when a user intends to upload acquired content to the storage device 3 and publish the content by mistake, since it is possible to prevent the content from being published in duplicate, infringement of right caused by error can be avoided.

According to the embodiment of the invention, a right holder of content who ascertained that content whose right is owned by him/herself is illegally published by a third party can easily request an operating administrator of a storage device to which the content is illegally published to manage the content, for example, to stop the publication or delete the content since the management of content publication source is unified.

According to the embodiment of the invention, since information of a poster and an acquirer of content is embedded to the published content as a digital watermark, it is possible to contact the poster and the acquirer when the content is illegally published. In addition, since the information of the acquirer is embedded to the acquired content, deterrent effect on illegal use of the content by the acquirer can be expected.

According to the embodiment of the invention, it becomes easy to specify a poster of content who should be contacted to obtain a license when secondary use of the published content, including commercial use, is desired. Accordingly, it is possible to prevent a creator or a right holder of the content from losing profits which can be originally obtained by him/her due to the poster of the content being unspecified.

According to the embodiment of the invention, by storing a name of a user who acquired the published content and the date and time when the content was acquired in the publishing content table 500, an administrator of the content publishing system can use the information to specify a distribution source of the content. In addition, the poster can ascertain how many times the content which the poster him/herself published was acquired by other users and therefore can use the number of times as a criterion for checking the popularity of the published content.

According to the embodiment of the invention, since the storage device 3 includes the original content retention unit 304 and the publishing content retention unit 308, even content which has already been published by other person can be stored in the original content retention unit 304. For example, when the published content is acquired for the purpose of private use, the backup can be stored in the storage device 3.

According to the embodiment of the invention, when a user other than a poster acquires published content, content to which user information or the like is embedded as a digital watermark is acquired. However, in the case of a poster, original content not embedded with a digital watermark is acquired from the original content retention unit 304.

According to the embodiment of the invention, since the management of content publication source can be unified, a provider of a service using the storage device 3 of the invention can avoid being taken to task by a content right holder about responsibilities for leaving a publication of illegal content, for example. In addition, since the management of content publication source is unified, content which is illegally published can be easily deleted in accordance with a request of deletion or the like from a content right holder.

### MODIFIED EXAMPLE

Finally, a modified example of the embodiment of the invention will be described.

In the storage device 3 according to the embodiment of the invention, content not embedded with a digital watermark is stored in the original content retention unit 304, while content embedded with a digital watermark is separately stored in the publishing content retention unit 308. However, only the content embedded with a digital watermark may be stored. That is, the storage device 3 may be configured to only include the publishing content retention unit 308 without including the original content retention unit 304. With this configuration, the required storage capacity can be reduced.

For example, the configuration having no original content retention unit 304 described above is suitable for a content publishing system with emphasis on publishing function which is based on the assumption that all content stored in the storage device 3 will be published.

In addition, in the case of the configuration having no original content retention unit 304, some parts of the upload processing 600 can be omitted. Specifically, it is assumed that the content is published, setting of whether “to be published” or “not to be published” is not required in the processing of S604 in FIG. 6. Further, only the acceptance of content is processed in the processing of S605, and it is determined whether or not the content is stored in the storage device 3 after determining the presence or absence of the duplicate content. The processing of S606 becomes unnecessary since it is assumed that all content are published. Accordingly, when the duplicate content of the accepted content exists in the storage device 3, the accepted content is discarded without being stored in the storage device 3.

The original content retention unit 304 and the publishing content retention unit 308 may be configured to be one component. In this case, content not embedded with a digital watermark and content embedded with a digital watermark may be stored in different directories, or a specific prefix may be assigned to a file name of content not embedded with a digital watermark.

In the storage device 3 according to the embodiment of the invention, content embedded with a digital watermark is stored in the publishing content retention unit 308. However, content embedded with a digital watermark may be automatically generated at a timing when the acquisition of content is requested to the published content acquisition request acceptance unit 310. In this case, since the publishing content retention unit 308 is unnecessary, the required storage capacity can be reduced.

The embodiment of the invention and the modified example thereof have been described. However, the above-mentioned embodiment is for the purpose of facilitating the understanding of the invention and does not limit the interpretation of the invention. The invention may be changed or altered without departing from the gist thereof as well as the invention includes the equivalents thereof.

What is claimed is:

1. A storage device which provides a storage area for storing content in accordance with a request from a user and can publish the stored content, comprising:
an interface;
a processor connected to the interface; and
a memory connected to the processor, wherein
the memory stores user management information including identification information of a user who can access the storage area,
the storage area includes publishing content storage area which publishes the stored content to outside, and
the processor
accepts a content storage request from the user,
generates duplication identification information for determining duplication of content based on the accepted content,
determines whether or not duplicate content of the accepted content is stored in the storage area based on-the generated duplication identification information,
embeds a digital watermark including identification information of the user to the accepted content, thereby generating publishing content if the duplicate content of the accepted content is not stored in the storage area,
stores the publishing content in the publishing content storage area, and
does not store the content in the publishing content storage area if the duplicate content of the accepted content is stored in the storage area.

2. The storage device according to claim 1, wherein
the processor
accepts a content acquisition request from a viewer of the publishing content,
generates acquiring content embedded with a digital watermark including the identification information of the user and identification information of the viewer, and
provides the generated acquiring content to the viewer.

3. The storage device according to claim 2, wherein
the storage area further includes an original content storage area storing the accepted content, and
the processor
stores the accepted content in the original content storage area, and
provides the content stored in the original content storage area to the viewer if the identification information of the viewer matches the identification information of the user.

4. The storage device according to claim 2, wherein
the memory stores publishing content management information which manages the publishing content stored in the publishing content storage area, and
the processor records information of the viewer who acquired the generated acquiring content in the publishing content management information.

5. The storage device according to claim 1, wherein
the processor accepts a direction whether or not the accepted content is published.

6. The storage device according to claim 5, wherein
the storage area further includes an original content storage area storing the accepted content, and
the processor
stores the accepted content in the original content storage area, and
stores the publishing content in the publishing content storage area if it is commanded to publish the accepted content.

7. The storage device according to claim 1, wherein
the storage area further includes an original content storage area storing the accepted content,
the memory stores original content management information which manages content stored in the original content storage area and publishing content management information which manages publishing content stored in the publishing content storage area, and
the processor
accepts input of information necessary for registering the user information if the identification information of the user is not included in the user management information,
accepts a direction whether or not the accepted content is published,
stores the accepted content in the original content storage area,
records the generated duplication identification information in the original content management information if it is commanded to publish the accepted content,
determines whether or not duplicate content of the accepted content is stored in the storage area based on the generated duplication identification information and the original content management information,
stores the publishing content in the publishing content storage area if the duplicate content of the accepted content is not stored in the storage area,
accepts a viewing request from a viewer who wants to view the publishing content,
accepts input of information necessary for registering the user information if identification information of the viewer is not included in the user management information,
accepts an acquisition request of the publishing content from the viewer,
provides the content stored in the original content storage area to the viewer if the identification information of the viewer matches the identification information of the user,
generates acquiring content embedded with a digital watermark including the identification information of the user and the identification information of the viewer if the identification information of the viewer does not match the identification information of the user,
provides the generated acquiring content to the viewer, and
records information of the viewer who acquired the generated acquiring content in the publishing content management information.

8. A content publishing system comprising a terminal and a storage device which provides a storage area for storing content in accordance with a request from a user via the terminal and can publish the stored content, wherein
the storage device includes an interface, a processor connected to the interface, and a memory connected to the processor,
the memory stores user management information including identification information of a user who can access the storage area,
the storage area includes publishing content storage area which publishes the stored content to outside,
the terminal
accepts a content storage request from the user, and
transmits the accepted storage request including content to the storage device, and
the storage device
receives the accepted storage request including the content from the terminal,
generates duplication identification information for determining duplication of content based on the accepted content,
determines whether or not duplicate content of the accepted content is stored in the storage area based on the generated duplication identification information,
embeds a digital watermark including identification information of the user to the accepted content, thereby generating publishing content if the duplicate content of the accepted content is not stored in the storage area,
stores the publishing content in the publishing content storage area, and
does not store the content in the publishing content storage area if the duplicate content of the accepted content is stored in the storage area.

9. The content publishing system according to claim 8, wherein
the terminal
accepts a content acquisition request from a viewer of the publishing content, and
transmits the accepted content acquisition request to the storage device,
the storage device
generates acquiring content embedded with a digital watermark including the identification information of the user and identification information of the viewer based on the content acquisition request received from the terminal, and
transmits the generated acquiring content to the terminal, and
the terminal provides the acquiring content transmitted from the storage device to the viewer.

10. A program executed in a storage device which provides a storage area for storing content in accordance with a request from a user and can publish the stored content,
the storage device storing user management information including identification information of a user who can access the storage area,
the storage area including publishing content storage area which publishes the stored content to outside,
the program comprising:
receiving a content storage request from the user;
generating duplication identification information for determining duplication of content based on the accepted content;
determining whether or not duplicate content of the accepted content is stored in the storage area based on the generated duplication identification information;
embedding a digital watermark including identification information of the user to the accepted content, thereby generating publishing content if the duplicate content of the accepted content is not stored in the storage area; and
storing the publishing content in the publishing content storage area.

11. The program according to claim 10, further comprising:
accepting a content acquisition request from a viewer of the publishing content;
generating acquiring content embedded with a digital watermark including the identification information of the user and identification information of the viewer; and
providing the generated acquiring content to the viewer.

12. The program according to claim 11, wherein
the storage area further includes an original content storage area storing the accepted content,
the program further comprising:
storing the accepted content in the original content storage area; and
providing content stored in the original content storage area to the viewer if the identification information of the viewer matches the identification information of the user.

13. The program according to claim 11, wherein
the storage device stores publishing content management information which manages publishing content stored in the publishing content storage area,
the program further comprising recording information of the viewer who acquired the generated acquiring content in the publishing content management information.

14. The program according to claim 10, further comprising accepting a direction whether or not the accepted content is published.

15. The program according to claim 14, wherein
the storage area further includes an original content storage area storing the accepted content,
the program further comprising:
storing the accepted content in the original content storage area; and
storing the publishing content in the publishing content storage area if it is commanded to publish the accepted content.
